(19) United States
(12) Patent Application Publication
(10) Pub. No.: US 2015/0013659 A1
(43) Pub. Date: Jan. 15, 2015

(54) TILE CUTTING MACHINE

(71) Applicant: CHERVON INTELLECTUAL PROPERTY LIMITED, Road Town (VG)

(72) Inventor: Zhifeng Chen, Nanjing (CN)

(21) Appl. No.: 14/320,778

(22) Filed: Jul. 1, 2014

(30) Foreign Application Priority Data
Jul. 2, 2013 (CN) 201310276535.7

(51) Int. Cl. B28D 7/04; B28D 1/24; B28D 1/04

(52) U.S. Cl. CPC B28D 7/043; B28D 1/047; B28D 1/24
USPC 125/13.01

(57) ABSTRACT

A tile cutting machine comprises a base, a motor accommodated in the base, a blade driven to rotate by the motor, and a working table supported on the base, wherein the working table comprises a fixed working table fixedly mounted to the base. A movable working table is slidably mounted to the fixed working table in a sliding direction parallel to a plane of the blade. The movable working table comprises a pivoting plate pivotally mounted to the movable working table about a pivoting axis parallel to the plane where the blade is located and a fence assembly mounted to the movable working table. The tile cutting machine can effectively enhance the ability to produce straight and/or square cuts.

### FIELD OF THE DISCLOSURE

The present invention generally relates to a tile cutting machine, and more particularly to a working table of the tile cutting machine.

### BACKGROUND OF THE DISCLOSURE

Tile cutting machines are widely used for cutting tiles such as ceramic tile and earthenware tile. Current tile cutting machines typically comprise a base, a motor arranged in the base, a blade rotatably driven by the motor, and a working table supported on the base. The working table has an elongated opening at the middle thereof, and the blade extends out from the elongated opening and is partially positioned above the working table. During operation, a workpiece to be cut is positioned on the working table, and an operator pushes the workpiece to be cut towards the rotating blade slowly so as to perform a cutting operation.

The above-described tile cutting machine has lots of disadvantages. Firstly, the operator needs to manually push the workpiece to be cut for performing a cutting operation, and it is oftentimes difficult to control the workpiece to be cut such that it travels in a straight direction. Thus, this operation tends to cause the cutting surface to be crooked, and cannot ensure the straightness of the resulting cut, thereby affecting the cut quality. Secondly, when performing an inclined cutting operation, the operator needs to manually keep the workpiece to be cut in an inclined position with one hand and while pushing the workpiece to be cut with the other hand. This operation depends upon two hands to control the workpiece to be cut, which is difficult to keep the workpiece to be cut in the desired position and tends to cause an unstable cutting operation and relatively low cutting quality. Additionally, controlling the inclinded workpiece may be difficult, which may result in an increased workload on the blade and motor, thereby sometimes resulting in a seized motor. Still Further, the workpiece to be cut may slide on the working table, and overtime, the friction between the workpiece to be cut and the working table may scratch and/or deform the surface of the working table, which may cause the surface of the working table to be uneven, so that the workpiece to be cut is positioned in a non-horizontal position on the working table, that is, the workpiece to be cut is not vertical to the blade, thus the resulting cutting surface is not a vertical surface.

### SUMMARY

One object of the present invention is to overcome the deficiencies existing in the prior art, and provide a tile cutting machine having a movable working table.

The tile cutting machine according to the present invention comprises a base; a motor accommodated in the base; a blade rotabably driven by the motor; a working table supported on the base; wherein the working table comprises a fixed working table fixedly mounted to the base and a movable working table slidably mounted to the fixed working table in a sliding direction parallel to a plane where the blade is located, the movable working table comprising a pivoting plate pivotally mounted to the movable working table about a pivoting axis parallel to the plane where the blade is located; and a fence assembly mounted to the movable working table.

The working table of the tile cutting machine of the present invention comprises a fixed working table and a movable working table. The movable working table can slide relative to the fixed working table, and the movable working table is mounted with a fence assembly, thus the workpiece to be cut may be better positioned on the working table. During the cutting operation, the operator only needs to push the movable working table to slide, and does not need to push the workpiece to be cut as in the prior art. With better positioned, the workpiece to be cut does not tend to displace which affects the cutting quality, effectively enhancing the straightness and squareness of the cutting. In addition, during the cutting operation, the workpiece to be cut is fixed relative to the movable working table, and there is a relative sliding, i.e., friction, only between the workpiece to be cut and the fixed working table, which reduces the friction and thus the scrape on the working table as compared with the prior art.

### BRIEF DESCRIPTION OF THE DRAWINGS

FIG. 1 is a schematic view of a tile cutting machine according to one embodiment of the present invention.

FIG. 2 is an exploded view of the tile cutting machine.

FIG. 3 is an exploded view of a fixed working table of the tile cutting machine.

FIG. 4 is an exploded view of a fence assembly of the tile cutting machine.

FIG. 5 is a top view of the tile cutting machine.

FIG. 6 is a top view of the tile cutting machine in another state.

FIG. 7 is an exploded view of a movable working table of the tile cutting machine.

FIG. 8 is a schematic view showing the tile cutting machine performing an inclined cutting operation.

### DETAILED DESCRIPTION

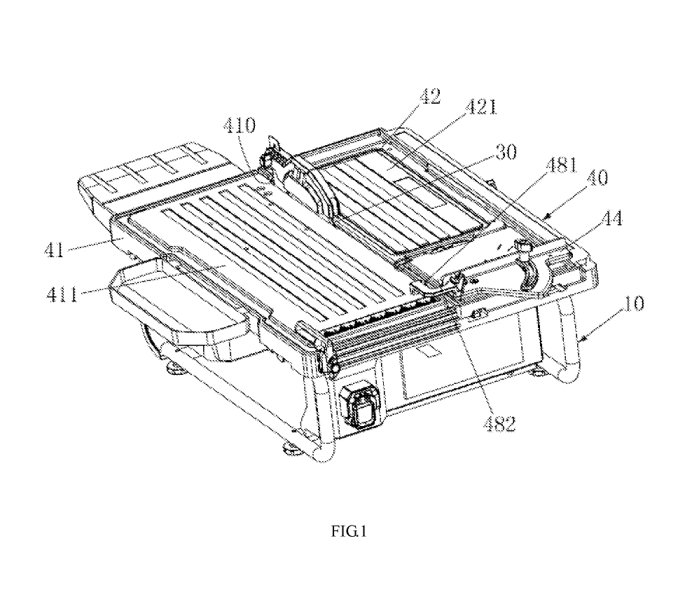

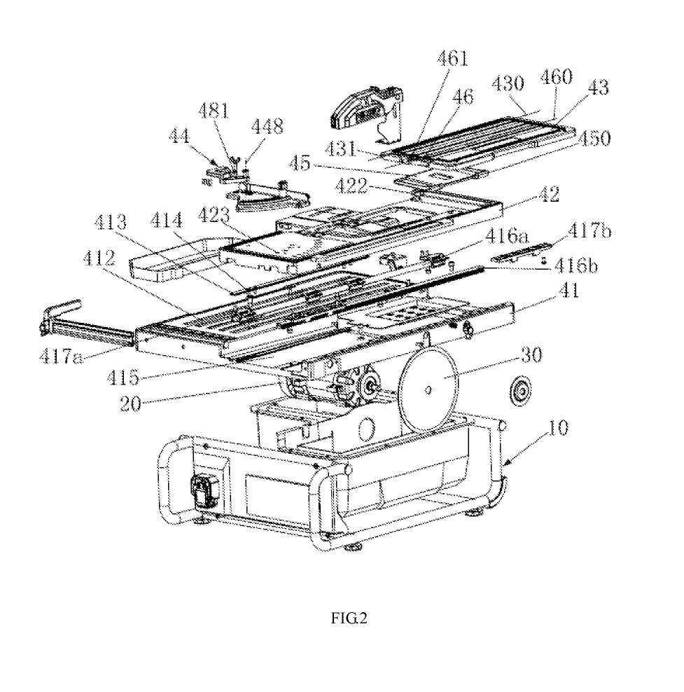

As shown in FIG. 1, a tile cutting machine according to one embodiment of the present invention comprises a base 10, a motor 20 (as shown in FIG. 2) accommodated in the base 10, a blade 30 rotatably driven by the motor 20 and a working table assembly 40 supported on the base 10.

As shown in FIG. 2, the working table assembly 40 comprises a fixed working table 41 and a movable working table 42.

The fixed working table 41 covers the whole base 10. The fixed working table 41 has an elongated opening 410 at the middle thereof, and the blade 30 extends out from the elongated opening 410 and is partially positioned above the fixed working table 41. The top surface of the fixed working table 41 is formed at one side of the blade 30 as a first supporting surface 411 for supporting a workpiece (not shown) to be cut. The first supporting surface 411 is formed with a plurality of grooves 412 for accommodating an adjusting piece 413. The grooves 412 extend in the direction parallel to the plane where the blade 30 is located and are parallel to each other. The shape of the adjusting piece 413 may be substantially the same as that of the grooves 412. The top surface of the adjusting piece 413 forms a portion of the first supporting surface 411. The adjusting piece 413 may be mounted in the groove 412 by a screw 414 having an spring piece (not shown), and the position of the adjusting piece 413 in the vertical direction may be adjusted by rotating the screw 414. In other embodiments, the adjusting piece 413 may be mounted to the grooves 412 by other mounting means to allow for an adjustment in the vertical direction.

The fixed working table 41 is formed with a first concave portion 415 for accommodating the movable working table 42 at the other side of the blade 30. The first concave portion 415 is communicated in the direction parallel to the plane where the blade 30 is located. The bottom surface of the first concave portion 415 is formed with two rectangular grooves 418 for mounting a first rail 416a and a second rail 416b, respectively. The first rail 416a and the second rail 416b each have a flat bottom surface for engaging with the rectangular grooves 418. The first rail 416a is substantially cylindrical and the second rail 416b has an “I” shaped section. The first rail 416a and the second rail 416b extend in the direction parallel to the plane where the blade 30 is located. The bottom surface of the movable working table 41 is mounted with a first sliding block 417a and a second sliding block 417b for engaging with the first rail 416a and the second rail 416b, so that the movable working table 42 can slide relative to the fixed working table 41 and even slide beyond the fixed working table 41, thereby enlarging the supporting area of the working table assembly 40. The top surface of the movable working table 42 is formed as a second supporting surface 421 for supporting the workpiece to be cut. The first supporting surface 411 and the second supporting surface 421 are coplanar and can support the workpiece to be cut together.

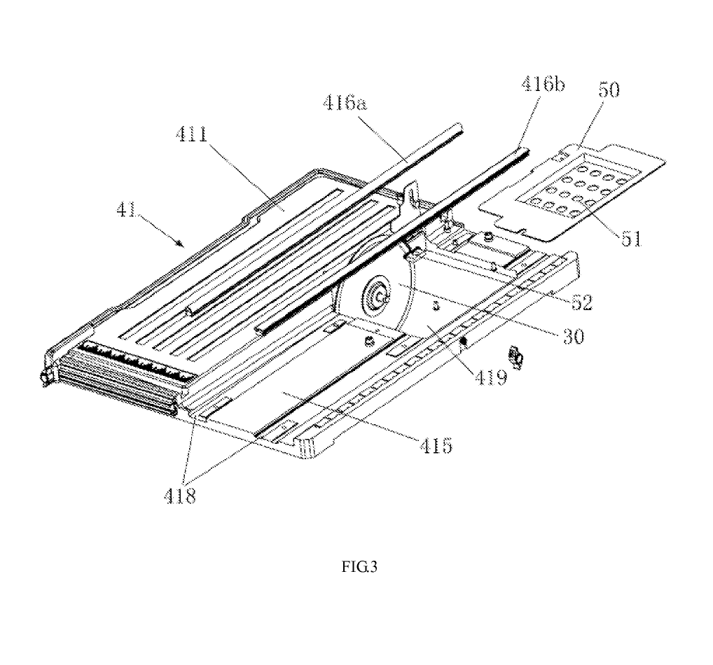

As shown in FIG. 3, the first concave portion 415 has a receiving hole 419 adjacent to the blade 30 for receiving a filtering plate 50. The receiving hole 419 is in communication with the elongated opening 410. The edge of the filtering plate 50 is engaged with the bottom surface of the first concave portion 415. In the assembled state, the filtering plate 50 covers a portion of the blade 30 so as to facilitate the replacement of the blade 30 on one hand and prevent the blade 30 from being completely exposed outwards directly, thereby providing protection. The filtering plate 50 is provided with a plurality of apertures 51 therein so that a cooling liquid used in the cutting process may be filtered by and flowed out of the filtering plate 50 to a water tank (not shown) arranged in the base 10. The filtering plate 50 is provided at one side adjacent to the blade 30 with a brush 52 for preventing the cooling liquid splashing.

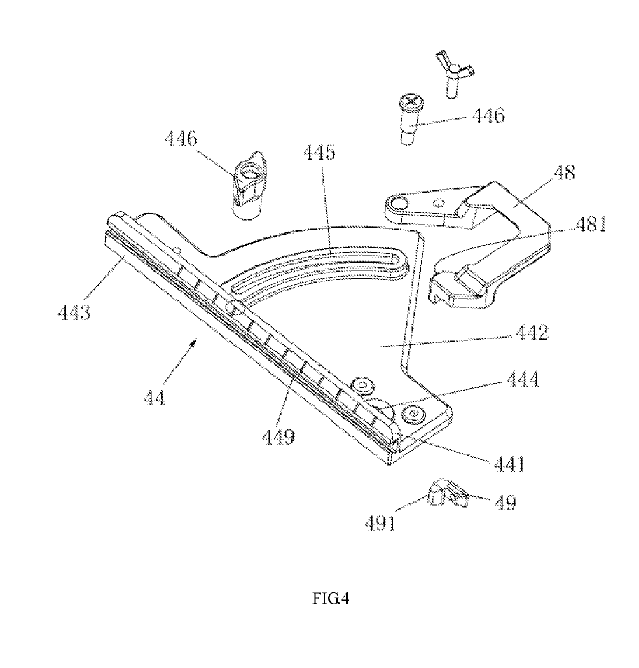

As shown in FIGS. 1 and 4, a front end of the movable working table 42 is provided with a fence assembly 44 for supporting the workpiece to be cut. The fence assembly 44 comprises a main fence 441 and a base plate 442 perpendicular to the main fence 441. The main fence 441 has a third supporting surface 443 vertical to the movable working table 42 for supporting the workpiece to be cut in the vertical direction. The base plate 442 is formed with a mounting hole 444 on one end thereof and an arc slot 445 on the other end. The arc slot 445 takes the center of the mounting hole 444 as a center of a circle, and a positioning bolt 447 cooperates with the arc slot 445. The fence assembly 44 is rotatably connected to the movable working table 42 by a fastening bolt 446. Specifically, the fastening bolt 446 passes through the mounting hole 444 and is mounted to the movable working table 42. When the fastening bolt 446 is released, the fence assembly 44 can rotate relative to the movable working table 42, and the center line of the mounting hole 444 forms a rotating axis 448 of the fence assembly 44 vertical to the movable working table 42. The movable working table 42 is formed with a plurality of positioning holes 423 and the positioning bolt 446 may cooperate with one of the positioning holes 423 so that the fence assembly 44 can be fixed in the desired angle position.

The front end herein refers to the end adjacent to the operator during operation; contrarily, the back end refers to the end further away from the operator during operation.

When a cutting operation is performed, the workpiece to be cut is positioned on the working table assembly 40, one edge of the workpiece to be cut abuts against the main fence 441, the bottom surface of the workpiece to be cut is supported by the first supporting surface 411 and the second supporting surface 421, and the other edge of the workpiece to be cut is supported by the third supporting surface 443, thus the workpiece to be cut may be better positioned in both the horizontal and vertical direction. The movable working table 42 is pushed by the operator to slide relative to the fixed working table 41, and the workpiece to be cut on the movable working table 42 is slowly pushed towards the blade 30 for performing a cutting operation. When performing a bevel cutting operation, the operator needs to rotate the fence assembly 44 by a certain angle and then perform the cutting operation. During the cutting process, the workpiece to be cut does not move in any undesirable manner, thereby solving the problem in the prior art that the workpiece to be cut cannot be controlled by depending on the hands of the user to push the workpiece to be cut.

During the cutting process, friction exists only between the workpiece to be cut and the first supporting surface 411 of the fixed working table 41. The workpiece to be cut is fixed relative to the movable working table 41 so that no friction exists between them. Thus, as compared with the tile cutting machine in the prior art, the tile cutting machine of the present invention can reduce the friction between the workpiece to be cut and the working table, thereby reducing the resultant damage to the working table. When the first supporting surface 411 of the fixed working table 41 is damaged, the operator may adjust the position of the adjusting piece 413 in the vertical direction, keeping the first supporting surface 411 coplanar with the second supporting surface 421.

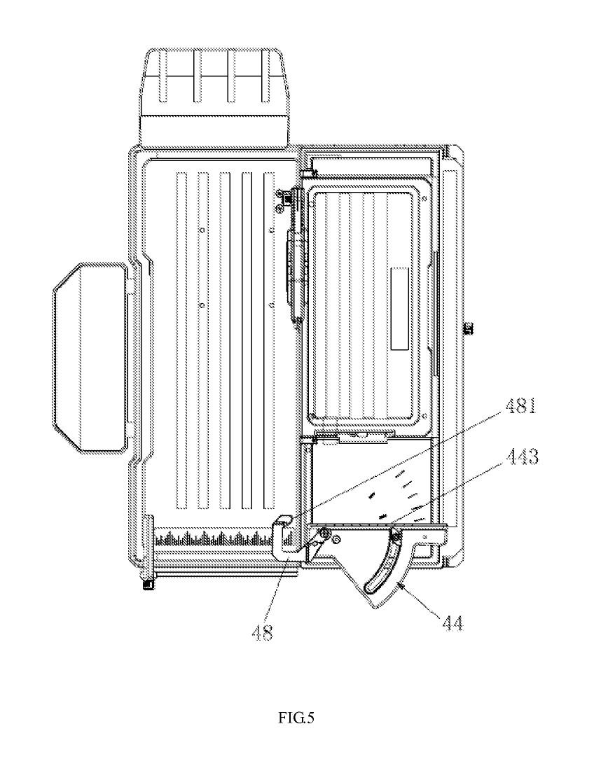

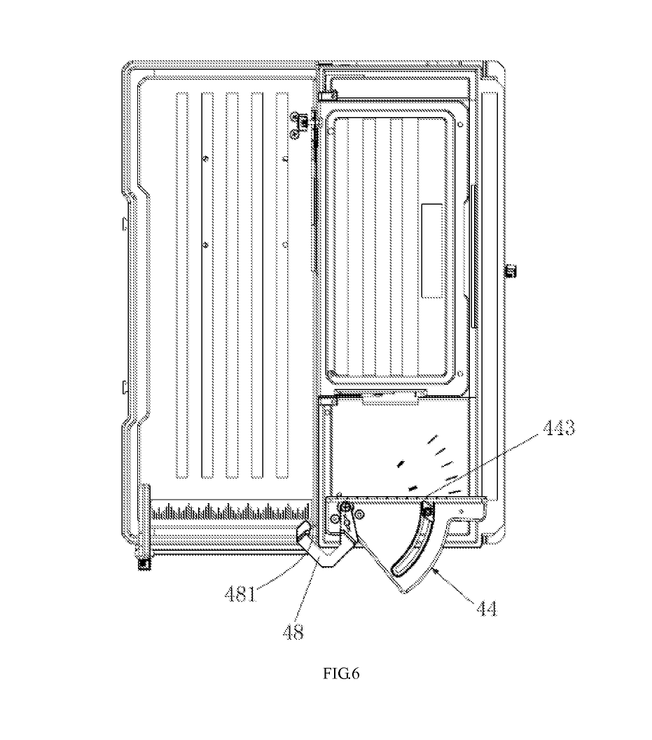

The fence assembly 44 is further provided with a U-shaped, first stopping block 48. One end of the first stopping block 48 is rotatably connected to the fence assembly 44 through the fastening bolt 446 and the other end is formed with a fourth supporting surface 481 vertical to the movable working table 42 for supporting the workpiece to be cut. The first stopping block 48 may be rotated between a working state and a non-working state. As shown in FIGS. 1 and 5, the fourth supporting surface 481 is vertical to and spaced from the third supporting surface 443. As illustrated, the first stopping block 48 is in the working state, and the third supporting surface 443 and the fourth supporting surface 481 cooperate to support an right angle of the workpiece to be cut, thereby preventing the workpiece to be cut from undesirable displacement. When the operator rotates the fence assembly 44 together with the first stopping block 48 to enable the right angle of the workpiece to be cut is aligned with the blade 30, a symmetrical diagonal cut may be achieved. In the working state, the U-shaped, first stopping block 48 enables the third supporting surface 443 and the fourth supporting surface 481 to be separated by a certain distance so as to form a gap 482 for accommodating the blade 30 during the cutting process, thereby preventing the blade 30 from interfering with the first stopping block 48. When a symmetrical diagonal cut is not needed, the first stopping block 48 is rotated to the front side of the main fence 441, i.e., to the position as shown in FIG. 6. In this illustration, the first stopping block 48 is the non-working state.

The third supporting surface 443 of the fence 441 is formed with a guiding groove 449 parallel to the movable working table 42 and extending in the longitudinal direction of the fence 441 for receiving and guiding a second stopping block 49. The second stopping block 49 is formed with a fifth supporting surface 491 vertical to the movable working table 42 and the third supporting surface 443. In the assembled state, the second stopping block 49 is mounted in the guiding groove 449 and can slide in the guiding groove 449. The third supporting surface 443 and the fifth supporting surface 491 cooperate to support a right angle of the workpiece to be cut, thereby preventing the workpiece to be cut from undesirable displacement. The operator can rotate the fence assembly 44 together with the second stopping block 49 so as to achieve the function of non-symmetrical diagonal cutting.

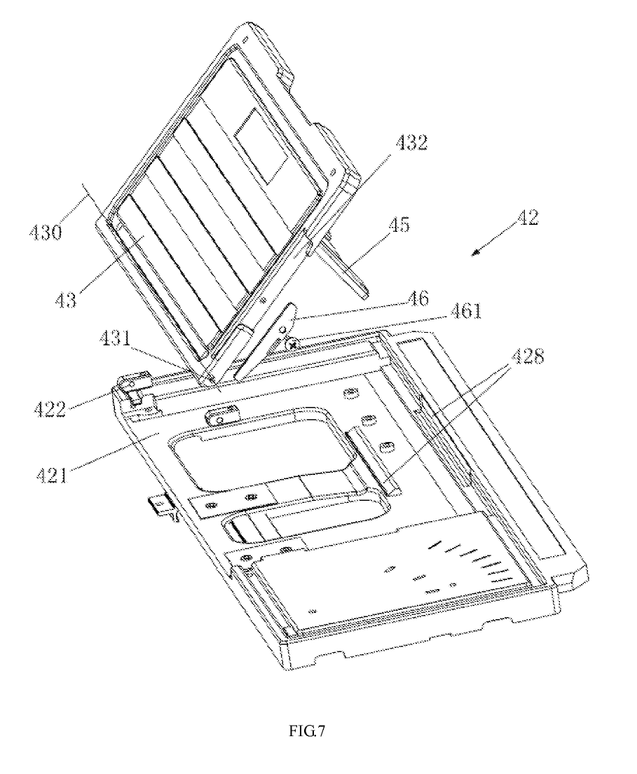

As shown in FIG. 7, the movable working table 42 is formed with a second concave portion 421 for accommodating a pivoting plate 43. The top surface of the pivoting plate 43 is formed as a portion of the second supporting surface 421. The movable working table 42 is provide at the side adjacent to the blade 30 with two pivoting base having a mounting hole 422. The pivoting plate 43 is provided with a pin shaft 431 for mating with the mounting hole 422 at the two sides in the direction parallel to the plane where the blade 30 is located. The central axis of the pin shaft 431 forms a pivoting axis 430 of the pivoting plate 43 parallel to the plane where the blade 30 is located. The pivoting plate 43 can rotate relative to the movable working table 42 around the pivoting axis 430, thereby achieving the function of an inclined cutting.

The bottom surface of the pivoting plate 43 is provided with a supporting bracket 45 for maintaining the pivoting plate 43 in the desired inclined position. The supporting bracket 45 can pivot relative to the pivoting plate 43. The pivoting mounting means may be replaced by a pin shaft and an opening mated with each other. A pivoting axis 450 of the supporting bracket 45 is parallel to the pivoting axis 430 of the pivoting plate 43. In the direction vertical to the plane where the blade 30 is located in, the pivoting axis 430 of the pivoting plate 43 is positioned at the side of the second concave portion 421 adjacent to the blade 30, and the pivoting axis 450 of the supporting bracket 45 is positioned at the side of the second concave portion 421 away from the blade 30. The second concave portion 421 is provided with two positioning strips 428 extending in the direction parallel to the plane where the blade 30 is located. Each positioning strip 428 has a positioning groove for engaging with the edge of the supporting bracket 45 so as to limit the supporting bracket 45 in the desired angle position. Preferably, the positioning groove is a V-shaped groove. Various positioning strips 428 can maintain the supporting bracket 45 at different angles. In other embodiments, the number of positioning grooves may be one or more. Correspondingly, the supporting bracket 45 and the pivoting plate 43 may be supported at one or two angle positions.

The front side wall of the pivoting plate 43 is formed with a cutout 432 for accommodating an auxiliary fence 46. The auxiliary fence 46 is rotatably mounted to the pivoting plate 43 by a bolt 461 having a central axis as a rotating axis 460 of the auxiliary fence 46 which is parallel to the plane where the blade 30 is located and parallel to the pivoting axis 430 of the pivoting plate 43. When the auxiliary fence 46 is not used, the auxiliary fence 46 is accommodated in the cut 432. When the auxiliary fence 46 is used to support the workpiece to be cut, the auxiliary fence 46 is rotated so that at least one portion thereof extends beyond the top surface of the pivoting plate 43.

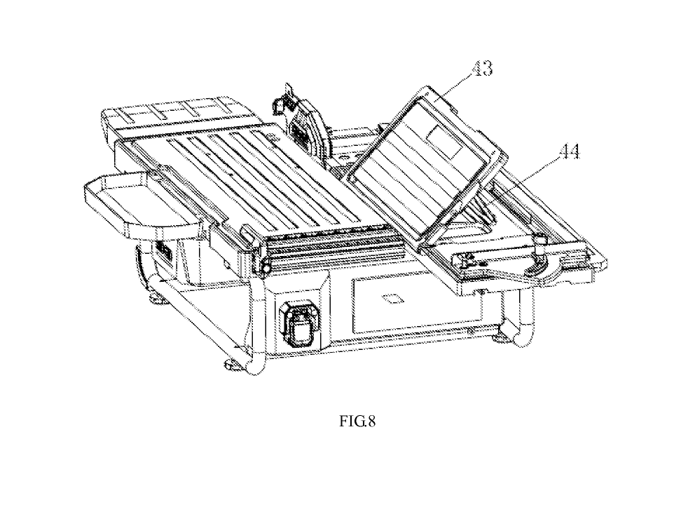

As shown in FIG. 8, when performing an inclined cutting operation, the pivoting plate 43 is firstly rotated to the desired position about the pivoting axis 430, and then the supporting bracket 45 is rotated about the pivoting axis 450 to engage with one of the positioning strips 428 so as to support and maintain the pivoting plate 43 at an inclined position. Next, the auxiliary fence 46 is rotated so that at least one portion thereof is positioned above the pivoting plate 43. The workpiece to be cut is positioned on the pivoting plate 43, and one edge of the workpiece to be cut abuts against the auxiliary fence 46. In this way, the fence workpiece to be cut can be better positioned, and the operator only needs to push the movable working table 42 to achieve an inclined cutting.

The working table of the tile cutting machine disclosed by the present invention is not limited to the contents in the above embodiments and the structures indicated by the drawings. The obvious changes, substitutions, and modifications to the shapes and positions of the members based on the present invention are contained in the protection scope of the present invention.

We claim:

1. A tile cutting machine, comprising:
a base;
a motor accommodated in the base;
a blade rotatably driven by the motor; and
a working table supported on the base,
wherein the working table assembly comprises:
a fixed working table fixedly mounted to the base;
a movable working table slidably mounted to the fixed working table, the sliding direction of which is parallel to a plane where the blade is located, the movable working table comprising a pivotal plate pivotally mounted to the movable working table about a pivoting axis parallel to the plane where the blade is located; and
a fence assembly mounted to the movable working table.

2. The tile cutting machine according to claim 1, wherein the fixed working table covers the whole base and has an elongated opening at the middle thereof, and the blade extends out from the elongated opening and is partially positioned above the fixed working table.

3. The tile cutting machine according to claim 2, wherein the fixed working table comprises a top surface at one side of the blade which defines a first supporting surface for supporting a workpiece to be cut, and the fixed working table comprises a first concave portion at the other side of the blade which is configured to accommodate the movable working table, and the movable working table has a top surface which defines a second supporting surface for supporting the workpiece to be cut and being coplanar with the first supporting surface.

4. The tile cutting machine according to claim 3, wherein a first rail and a second rail are mounted in the first concave portion and extend in a direction parallel to the plane where the blade is located, and a first sliding block and a second sliding block are mounted on a bottom surface of the movable working table for cooperating with the first rail and the second rail respectively, so that the movable working table is slidable relative to the fixed working table.

5. The tile cutting machine according to claim 3, wherein the first supporting surface is provided with a plurality of grooves for accommodating an adjusting piece with a top surface forming a portion of the first supporting surface, and the adjusting piece is mounted to the groove by an adjusting screw and the position of the adjusting piece in the vertical direction is adjusted by rotating the adjusting screw to enable the first supporting surface and the second supporting surface to be kept coplanar.

6. The tile cutting machine according to claim 3, wherein the first concave portion has a receiving hole for receiving a filtering plate in which the receiving hole is adjacent to the blade and being communicated with the elongated opening, the filtering plate partially covering the blade and having a plurality of leaks for cooling liquid to flow through.

7. The tile cutting machine according to claim 6, wherein the filtering plate is provided at one side adjacent to the blade with a brush for preventing the cooling liquid from splashing.

8. The tile cutting machine according to claim 4, wherein the movable working table has a second concave portion for accommodating the pivoting plate and a top surface of the pivoting plate is formed as a portion of the second supporting surface.

9. The tile cutting machine according to claim 8, wherein a supporting bracket for supporting the pivoting plate in a pivoting position is pivotally mounted to a bottom surface of the pivoting plate about a pivoting axis parallel to a pivoting axis of the pivoting plate, and the first concave portion is provided with at least one positioning groove for cooperating with the supporting bracket and maintaining the supporting bracket in the pivoting position.

10. The tile cutting machine according to claim 9, wherein an auxiliary fence is pivotally mounted to a front side wall of the pivoting plate about a pivoting axis parallel to the plane where the blade is located.

11. The tile cutting machine according to claim 1, wherein the fence assembly is rotatably mounted to the movable working table about a rotating axis vertical to the movable working table, and the fence assembly comprises a main fence having a third supporting surface which is used for supporting the workpiece to be cut and is vertical to the movable working table.

12. The tile cutting machine according to claim 11, wherein the fence assembly further comprises a first stopping block rotatably mounted to the fence assembly about a rotating axis vertical to the movable working table, the first stopping block having a fourth supporting surface vertical to the movable working table and being able to rotate between a working state and a non-working state, wherein in the working state, the fourth supporting surface is vertical to the third supporting surface and a gap for accommodating a portion of the blade is formed between the third supporting surface and the fourth supporting surface to enable a symmetrical diagonal cutting operation to be performed.

13. The tile cutting machine according to claim 12, wherein the fence assembly further comprises a second stopping block, and the third supporting surface of the main fence has a guiding groove for guiding the second stopping block to slide therein, the guiding groove being parallel to the movable working table, the second stopping block having a fifth supporting surface vertical to both the movable working table and the third supporting surface, and the third supporting surface and the fifth supporting surface cooperating with each other to perform an unsymmetrical diagonal cutting operation.
